(19) United States
(12) Patent Application Publication
(10) Pub. No.: US 2014/0021925 A1
(43) Pub. Date: Jan. 23, 2014

(54) BATTERY POWER SUPPLY APPARATUS AND BATTERY POWER SUPPLY SYSTEM

(71) Applicants: Jun Asakura, Hyogo (JP); Mutsuhiko Takeda, Osaka (JP); Yoshiki Ohsawa, Osaka (JP)

(72) Inventors: Jun Asakura, Hyogo (JP); Mutsuhiko Takeda, Osaka (JP); Yoshiki Ohsawa, Osaka (JP)

(73) Assignee: PANASONIC CORPORATION, Osaka (JP)

(21) Appl. No.: 14/009,107

(22) PCT Filed: Mar. 6, 2012
(86) PCT No.: PCT/JP2012/001539

§ 371 Date: Sep. 30, 2013

(30) Foreign Application Priority Data
Mar. 31, 2011 (JP) 2011-077637

(51) Int. Cl. H02J 7/00

(52) U.S. Cl. CPC H02J 7/0031
USPC 320/126

(57) ABSTRACT

A battery power supply apparatus has: a battery including a parallel circuit that has series circuits connected in parallel, each of the series circuits having a secondary battery and a cutoff element connected in series, each of the cutoff elements becoming a disconnected state, when an abnormality occurs in the secondary battery; a first detector detecting an overall current value flowing through the battery block; a second detector connected in parallel to the series circuits to detect a block voltage value of the battery block; a setting portion setting a current limit value; and an estimation portion estimating, as the number of valid batteries, the number of cutoff elements which have not become disconnected states, based on the overall current value and the block voltage value. The setting portion sets the current limit value so that the current limit value decreases as the number of valid batteries decreases.

### TECHNICAL FIELD

The present invention relates to a battery power supply apparatus that has a battery block with secondary batteries connected in parallel, and a battery power supply system using the battery power supply apparatus.

### BACKGROUND ART

In a conventional battery power supply apparatus for supplying power to a load circuit using secondary batteries, a battery block with secondary batteries connected in parallel has been commonly used for the purpose of securing a required level of output current for the load circuit.

In this type of battery power supply apparatus, in case of abnormalities such as the occurrence of overcurrent or overheating in some of the secondary batteries of the battery block, the secondary batteries can be deteriorated when the battery block is charged-discharged in the same way as in a normal state.

Therefore, there has been known a technology for detecting abnormality, such as disengagement or disconnection in some of the secondary batteries included in the battery block, and for turning switching elements or protection elements off when such an abnormality occurs to inhibit charge-discharge of the entire battery power supply apparatus (see Patent Documents 1, 2, for example).

However, the above technology may unfavorably inhibit charge-discharge of the entire battery power supply apparatus when an abnormality occurs in some of the secondary batteries included in the battery block.

For example, in a hybrid electric vehicle (HEV) with an engine and a motor, when the vehicle is run by the motor, the motor is driven by discharge current from the battery power supply apparatus, and the battery block is discharged. On the other hand, when an output from the engine is greater than a power required for running the HEV, a generator is driven by excess power of the engine to charge the battery block of the battery power supply apparatus. The HEV further uses the motor as a generator when braking or decelerating, and charges the battery block of the battery power supply apparatus with the regenerative power.

Therefore, in a case where the battery power supply apparatus is used in an application such as HEV, inhibiting charge-discharge of the battery power supply apparatus when an abnormality occurs in some of the secondary batteries of the battery block may result in stopping a running vehicle or generating overvoltage. The overvoltage is caused by not being able to absorb the power generated by the generator or the regenerative power in the battery power supply apparatus.
Patent Document 1: Japanese Patent Application Publication No. 2008-27658
Patent Document 2: Japanese Patent Application Publication No. 2008-71568

### SUMMARY OF INVENTION

The present invention solves the above conventional problems, and an object of the present invention is to provide a battery power supply apparatus capable of lowering a risk of deterioration of its secondary batteries without inhibiting charging-discharging of the entire battery power supply apparatus even in case of abnormalities occurring in some of the secondary batteries of a battery block, and a battery power supply system using this battery power supply apparatus.

A battery power supply apparatus according to one aspect of the present invention has: a battery block, which includes a parallel circuit that has series circuits connected in parallel, each of the series circuits having a secondary battery and a cutoff element connected in series, each of the cutoff elements becoming a disconnected state to disconnect a charge-discharge path of the secondary battery connected in series thereto, when an abnormality occurs in the secondary battery; a first detector that detects an overall current value flowing through the battery block; a second detector that is connected in parallel to the series circuits to detect a block voltage value of the battery block; a setting portion that sets a current limit value as an upper-limit tolerance of the overall current value; and an estimation portion that estimates, as the number of valid batteries, the number of cutoff elements which have not become disconnected states among the cutoff elements of the battery block, based on the overall current value detected by the first detector and the block voltage value detected by the second detector, wherein the setting portion sets the current limit value so that the current limit value decreases as the number of valid batteries estimated by the estimation portion decreases.

A battery power supply system according to one aspect of the present invention has: the above battery power supply apparatus; and an external device that charges and discharges the battery block of the battery power supply apparatus, wherein the external device has: a load circuit that receives discharge current supplied from the battery block; a current supplier that supplies charging current to the battery block; and a charge-discharge controller that adjusts the discharge current supplied from the battery block to the load circuit and the charging current supplied from the current supplier to the battery block, so that a current flowing through the battery block does not exceed the current limit value set by the setting portion.

### BRIEF DESCRIPTION OF DRAWINGS

FIG. 1 is a block diagram showing an example of a battery power supply system having a battery power supply apparatus according to the first embodiment of the present invention.

FIG. 2 is a flowchart showing an example of operations performed by the battery power supply apparatus shown in FIG. 1.

FIG. 3 is a diagram showing the relationship between block voltage values and current accumulated values according to the first embodiment.

FIG. 4 is a flowchart showing another example of the operations performed by the battery power supply apparatus shown in FIG. 1.

FIG. 5 is a block diagram showing an example of a battery power supply system having a battery power supply apparatus according to the second embodiment of the present invention.

FIG. 6 is a flowchart showing an example of operations performed by the battery power supply system according to the second embodiment of the present invention.

FIG. 7 is a diagram showing the relationship between the block voltage values and the current accumulated values according to the second embodiment.

FIG. 8 is a flowchart showing another example of the operations performed by the battery power supply system according to the second embodiment of the present invention.

FIG. 9 is a diagram showing the relationship between the block voltage values and the current accumulated values according to the embodiment shown in FIG. 8.

### DESCRIPTION OF EMBODIMENTS

Embodiments according to the present invention are now described hereinafter with reference to the drawings. In each of the drawings, the same reference numerals are used to designate the corresponding components, and the descriptions thereof are omitted accordingly.

### First Embodiment

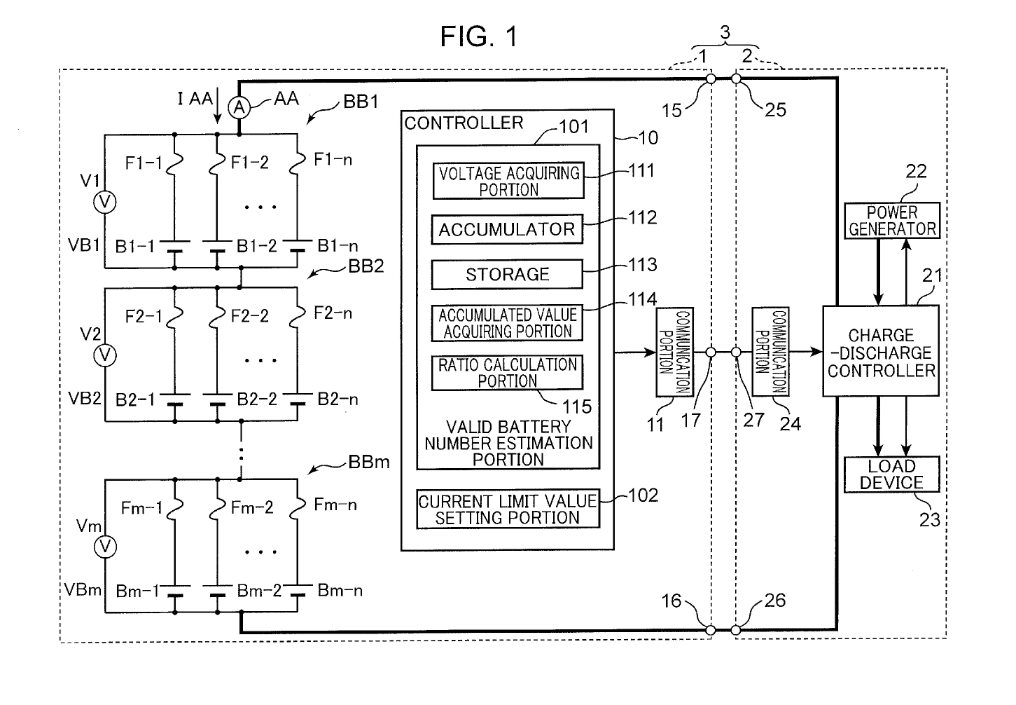

FIG. 1 is a block diagram showing an example of a battery power supply system having a battery power supply apparatus according to the first embodiment of the present invention.

A battery power supply system 3 shown in FIG. 1 is configured by a combination of a battery power supply apparatus 1 and an external device 2. The battery power supply apparatus 1 shown in FIG. 1 has m (e.g., ten) battery blocks BB1 to BBm, an overall current detector AA, a controller 10, a communication portion 11, and connection terminals 15, 16, 17.

The m battery blocks BB1 to BBm are connected in series. The positive electrode of the series circuit configured by the battery blocks BB1 to BBm is connected to the connection terminal 15 via the overall current detector AA. The negative electrode of the series circuit configured by the battery blocks BB1 to BBm is connected to the connection terminal 16. The connection terminal 17 is connected to the communication portion 11.

Note that the battery blocks BB1 to BBm in FIG. 1 are connected to one another by a single lead wire but may be connected by a plurality of lead wires. In other words, the battery blocks BB1 to BBm may be connected to one another at a plurality of sections thereof.

The external device 2 shown in FIG. 1 has a charge-discharge controller 21, a power generator 22 (a current supplier), a load device 23 (a load circuit), a communication portion 24, and connection terminals 25, 26, 27. The connection terminals 25, 26 are connected to the charge-discharge controller 21. The connection terminal 27 is connected to the charge-discharge controller 21 via the communication portion 24. The power generator 22 and the load device 23 are connected to the charge-discharge controller 21.

When the battery power supply apparatus 1 is combined with the external device 2, the connection terminals 15, 16, 17 are connected to the connection terminals 25, 26, 27, respectively.

The battery blocks BB1 to BBm all have the same configuration; thus, with the i^{th} battery block BBi as a representative of the battery blocks BB1 to BBm, the configuration of these battery blocks is now described below.

The battery block BBi is configured by connecting a basic cell number n (e.g., fifty) of series circuits, in which a fuse F as an example of a cutoff element is connected in series to a secondary battery B, in parallel. Hereinafter, in the battery block BBi illustrated in FIG. 1, the fuses F and the secondary batteries B included in each of the series circuits are represented as “fuses Fi-k” and “secondary batteries Bi-k” (k=1 to n), with the number “k” assigned to the fuses and the secondary batteries sequentially, starting from the left-hand side of the drawing.

First of all, in the series circuits of the battery block BBi, with the number k being 1 to n, the fuses Fi-k and the secondary batteries Bi-k are connected in series. A block voltage detector VBi for measuring a block voltage of the battery block BBi is connected in parallel to these series circuits.

Hereinafter, the battery blocks BB1 to BBm are collectively referred to as “battery blocks BB,”, fuses Fi-1 to Fi-n (i represents numbers 1 to m of the battery blocks) are collectively referred to as “fuses F.”, secondary batteries Bi-1 to Bi-n (i represents numbers 1 to m of the battery blocks) are collectively referred to as “secondary batteries B,” and the block voltage detector VBi is collectively referred to as “block voltage detectors VB.”

The overall current detector AA is configured with, for example, a Hall element, a shunt resistor, a current transformer, or the like.

The controller 10 acquires a value of a current flowing through the overall current detector AA and block voltage values of the battery blocks BB1 to BBm by converting voltages generated in the overall current detector AA and the block voltage detector VBi into digital values using, for example, an analog-digital converter.

Consequently, the overall current detector AA detects the overall current value IAA of a current flowing through the battery blocks BB1 to BBm. The block voltage detector VBi detects a block voltage value Vi (V1 to Vm) of each of the battery blocks BB1 to BBm.

Various secondary batteries such as a lithium ion secondary battery and a nickel hydrogen secondary battery may be used as the secondary batteries B. Note that each of the secondary batteries B may be a single cell or an assembled battery configured by connecting single cells in series or in parallel or by a combination of serial connection and parallel connection.

Each of the fuses F is configured to be disconnected in case of abnormality where, for example, the secondary battery B connected in series thereto short-circuits, to cut off the current flowing through the secondary battery B. In place of the fuses F, protection elements such as PTCs (Positive Temperature Coefficient) or CIDs (Current Interrupt Device) may be used as the cutoff elements.

The communication portions 11, 24 are communication interface circuits. Connecting the connection terminal 17 to the connection terminal 27 makes it possible for the communication portions 11, 24 to transmit and receive data to and from each other. The controller 10 and the charge-discharge controller 21 may transmit and receive data to and from each other via the communication portions 11, 24.

The controller 10 has, for example, a CPU (Central Processing Unit) for executing predetermined arithmetic processing, a ROM (Read-Only Memory) for storing a predetermined control program, a RAM (Random Access Memory) for temporarily storing data, an analog-digital converter, its peripheral circuit, and the like. The controller 10 functions as a valid battery number estimation portion 101 and a current limit value setting portion 102 by, for example, executing the control program stored in the ROM.

The valid battery number estimation portion 101 includes a voltage acquiring portion 111, an accumulator 112, a storage 113, an accumulated value acquiring portion 114, and a ratio calculation portion 115. At the start of its operation, the voltage acquiring portion 111 acquires, as a block voltage initial value Vai, the block voltage value Vi of the battery block BBi detected by the block voltage detector VBi. At a time when a current accumulated value becomes equal to or greater than a current accumulated threshold value Ith, the voltage acquiring portion 111 acquires a block voltage value Vbi of the battery block BBi detected by the block voltage detector VBi. At the start of its operation, the accumulator 112 starts accumulating current values detected by the overall current detector AA.

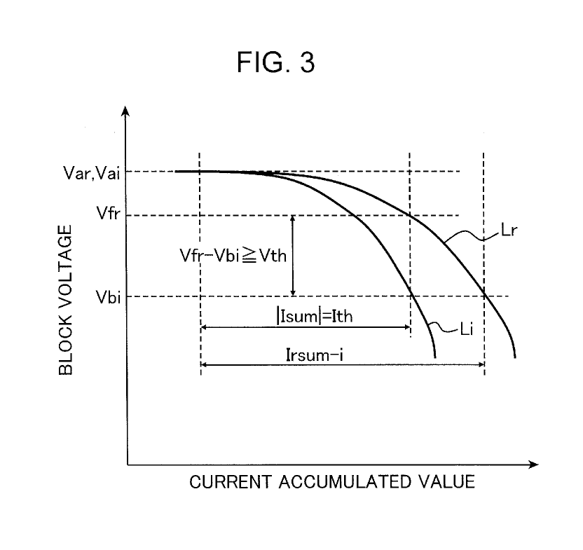

The storage 113 of the valid battery number estimation portion 101 stores a relationship (corresponding to a line Lr in FIG. 3) between voltages and electrical quantities (specifically, electrical discharge quantities, for example) in a case where all of the secondary batteries Bi of the battery block BBi are valid (i.e., where there are no disconnected fuses F). At the start of its operation, the accumulator 112 of the valid battery number estimation portion 101 starts accumulating the overall current value IAA detected by the overall current detector AA. When the resultant accumulated value obtained by the accumulator 112 reaches the constant current accumulated threshold value Ith, the accumulated value acquiring portion 114 calculates an estimated voltage value Vfr for each battery block BBi based on the above relationship stored in the storage 113. The accumulated value acquiring portion 114 then compares the block voltage value Vbi with the estimated voltage value Vfr. The block voltage value Vbi is detected when the current accumulated value reaches the current accumulated threshold value Ith. When there is a difference equal to or greater than a predetermined voltage threshold value Vth between the block voltage value Vbi and the estimated voltage value Vfr, the accumulated value acquiring portion 114 determines that the number of valid batteries is decreased. When the difference equal to or greater than the voltage threshold value Vth is not generated, the accumulated value acquiring portion 114 determines that the number of valid batteries is not decreased.

The voltage threshold value Vth is a threshold value which may determine that the number of valid batteries is decreased, when the current accumulated value reaches the current accumulated threshold value Ith. The voltage threshold value Vth is experimentally obtained beforehand and stored in the storage 113. The current accumulated threshold value Ith is a threshold value which surely generates a difference equal to or greater than the voltage threshold value Vth, when the number of valid batteries has decreased. The current accumulated threshold value Ith is experimentally obtained beforehand and stored in the storage 113.

The accumulated value acquiring portion 114 further acquires an ideal current accumulated value Irsum-i, described hereinafter, based on the block voltage value Vi of the battery block BBi acquired by the voltage acquiring portion 111 and based on the relationship between the block voltages and the electrical quantities stored in the storage 113. The ideal current accumulated value Irsum-i represents an ideal current accumulated value Irsum corresponding to the ith battery block BBi. In other words, the accumulated value acquiring portion 114 acquires the ideal current accumulated values Irsum-1 to Irsum-m of the battery blocks BB1 to BBm. Using the ideal current accumulated value Irsum-i, the ratio calculation portion 115 calculates a valid battery ratio, which is a ratio of the number of valid batteries ENi to the number of secondary batteries B (i.e., the basic cell number n) included in the single battery block BBi.

At this time, the current accumulated value Isum=Ith which has actually changed, is divided by the ideal current accumulated value Irsum-I under the condition that the number of valid batteries is not decreased. Then, the quotient is multiplied by the number of parallel secondary batteries (the basic cell number) n, and the product is, for example, rounded off to the nearest whole number, which is then calculated as the number of valid batteries ENi. The number of valid batteries ENi indicates the number of connected fuses, which are not cut off (disconnected) among the fuses Fi-1 to Fi-n of the battery block BBi.

The current limit value setting portion 102 sets a current limit value Iu which indicates the upper-limit tolerance of current flowing through the battery blocks BB (i.e., the overall current value IAA). Specifically, regarding one battery block BB, in a case where none of the fuses F included in the one battery block BB is disconnected, the upper limit value of the current capable of charging-discharging the one battery block BB is set beforehand as a standard current limit value Is. The current limit value setting portion 102 stores this preset standard current limit value Is.

Note that different values may be used as the standard current limit value Is when the battery block is charged and when the battery block is discharged. Alternatively, the standard current limit value Is may also be changed depending on the state of charge (SOC), temperature, or the like of the secondary batteries B.

For example, at low temperatures, the deterioration of the secondary batteries B accelerates more when charged than when discharged. Therefore, a standard charge current limit value Isc used at the time of charging may be set at a value smaller than a standard discharge current limit value Isd used at the time of discharging.

In addition, the standard charge current limit value Isc used at the time of charging may be set in such a manner as to approach zero as the SOC of the secondary batteries B increases to approach the fully charged state. The standard discharge current limit value Isd used at the time of discharging may also be set in such a manner as to approach zero as the SOC of the secondary batteries B decreases to approach an overdischarged state.

The valid battery number estimation portion 101 selects the minimum value from the numbers of valid batteries ENi (EN1 to ENm) of the battery blocks BB1 to BBm as the minimum valid battery number ENmin. The current limit value setting portion 102 calculates and sets the current limit value Iu based on the following formula (1) using the standard current limit value Is, the minimum valid battery number ENmin, and the basic cell number n, and then outputs the current limit value Iu to the communication portion 11.

Iu=Is×ENmin/n (1)

In the formula (1), ENmin/n corresponds to the valid battery ratio.

The communication portion 11 transmits the current limit value Iu, which is output from the current limit value setting portion 102, to the charge-discharge controller 21 via the communication portion 24. Consequently, the communication portion 11 causes the charge-discharge controller 21 to control the charging-discharging of the battery blocks BB in such a manner that the value of overall current IAA flowing through the battery blocks BB do not exceed the current limit value Iu.

The external device 2 is described next. The power generator 22 is, for example, a photovoltaic generation apparatus (solar cell), a generator that is driven by natural energy such as wind or water for example, or by artificial power such as an engine, and the like. Note that the charge-discharge controller 21 may be connected to, for example, a commercial power supply in place of the power generator 22.

The load device 23 is any of various loads that are driven by power supplied from the battery power supply apparatus 1. The load device 23 may be, for example, a motor or loading equipment of a backup target.

The charge-discharge controller 21 charges the battery blocks BB1 to BBm of the battery power supply apparatus 1 by means of surplus power obtained from the power generator 22 or regenerative power generated in the load device 23. The charge-discharge controller 21 supplies power to compensate a shortage of power from the battery blocks BB1 to BBm of the battery power supply apparatus 1 to the load device 23 when the consumption current of the load device 23 increases drastically or when electricity generated by the power generator 22 decreases so that the power demanded by the load device 23 exceeds the power provided by the power generator 22.

The charge-discharge controller 21 further receives the current limit value Iu from the current limit value setting portion 102 via the communication portions 11, 24. As described above, the charge-discharge controller 21 controls the charge-discharge current values of the battery blocks BB1 to BBm in such a manner that the overall current value IAA for charging-discharging the battery blocks BB1 to BBm do not exceed the current limit value Iu. In the present embodiment, the overall current detector AA corresponds to an example of the first detector, the block voltage detector VBi corresponds to an example of the second detector, the current limit value setting portion 102 corresponds to an example of the setting portion, and the valid battery number estimation portion 101 corresponds to an example of the estimation portion. Moreover, in the present embodiment, the voltage acquiring portion 111 corresponds to an example of first and second acquiring portions, the accumulated value acquiring portion 114 corresponds to an example of the third acquiring portion, and the ratio calculation portion 115 corresponds to an example of the calculation portion. In the present embodiment, the block voltage initial value Vai corresponds to an example of the first block voltage value, and the block voltage value Vbi corresponds to an example of the second block voltage value. In addition, in the present embodiment, the communication portion 11 corresponds to an example of the current controller. In the present embodiment, the load device 23 corresponds to an example of the load circuit, and the power generator 22 corresponds to an example of the current supplier.

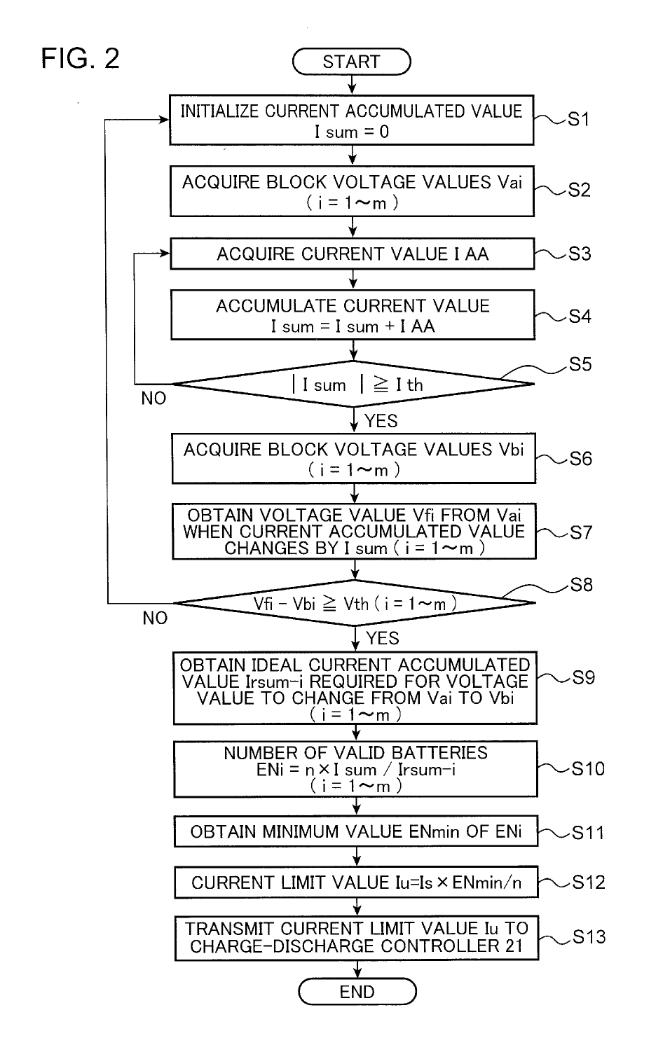

Next are described operations of the battery power supply system 3 of the first embodiment that is configured as described above. FIG. 2 is a flowchart showing an example of the operations performed by the battery power supply apparatus 1 shown in FIG. 1. FIG. 3 is a diagram showing the relationship between the block voltage values of each battery block BB and the current accumulated values of the overall current value IAA according to the first embodiment.

In FIG. 3, the horizontal axis represents the current accumulated values, and the vertical axis represents the block voltages. A line Lr shows a relationship between the block voltage value of a battery block and the current accumulated value of the overall current value in a case where none of the cutoff elements (fuses F) is disconnected, with the initial block voltage being a block voltage initial value Var. The line Lr is obtained by linearly interpolating the values stored in a table of the storage 113 of the valid battery number estimation portion 101. A line Li shows a relationship between the block voltage values of the battery block BBi and the current accumulated values of the overall current value in a case where any of the cutoff elements (fuses F) is disconnected, with the initial block voltage being the block voltage initial value Vai (Var=Vai in FIG. 3). In other words, in the battery block BB with no disconnected fuse F, the block voltage value and the current accumulated value transition along the line Lr. In the battery block BB with a disconnected fuse F, on the other hand, the block voltage value and the current accumulated value, of which the slant of decline is greater than that of the line Lr, transition along, for example, the line Li.

In the line Li with a disconnected fuse F, the block voltage value Vbi represents a block voltage at a time when the absolute value |Isum| of the current accumulated value reaches the current accumulated threshold value Ith, as a result of repeating the charging and discharging of the battery block BBi which start from the block voltage initial value Vai. When this block voltage value Vbi is applied to the line Lr with no disconnected cutoff element, the current accumulated value between the block voltage initial value Vai and the block voltage value Vbi becomes the ideal current accumulated value Irsum-i which is greater than the current accumulated threshold value Ith. Here, the block voltage values Vai, Vbi represent the block voltage values of the ith battery block BBi. In the line Lr, the voltage value, which is estimated in a case where the absolute value |Isum| of the current accumulated value becomes equal to the current accumulated threshold value Ith, is the estimated voltage value Vfr.

When the absolute value |Isum| of the current accumulated value reaches the current accumulated threshold value Ith, the block voltage value Vbi depends on the number of disconnected fuses F, and hence, the block voltage value Vbi may be a different value for each battery block BBi. Consequently, the ideal current accumulated value Irsum-i may be a different value for each battery block BBi. On the other hand, the estimated voltage value Vfr becomes a constant value, regardless of the battery block BBi, because the line Lr represents a fixed relationship and the current accumulated threshold value Ith is a constant value. Note that FIG. 3 illustrates a case where the current accumulated value is negative (discharging in view of the secondary battery B), but the same is true for a case where the current accumulated value is positive (charging in view of the secondary battery B).

The operations are described with reference to FIG. 2. First, when there is no abnormality in any of the secondary batteries B of the battery blocks BB1 to BBm and none of the fuses F thereof is disconnected (fused), the current limit value setting portion 102 sets the standard current limit value Is as the initial value of the current limit value Iu. Further, the current limit value setting portion 102 notifies the charge-discharge controller 21 of this current limit value Iu.

In this manner, the absolute value of the value of overall current IAA flowing through each of the battery blocks BB1 to BBm is controlled by the charge-discharge controller 21 so as not to exceed the standard current limit value Is.

Next, in order to initialize the current accumulated value, 0 is assigned to the current accumulated value Isum (step S1). The voltage acquiring portion 111 acquires the block voltage value Vi detected by the block voltage detector VBi, and stores it in, for example, the storage 113 as the block voltage initial value Vai (step S2). This step S2 is executed for the battery blocks BB1 to BBm. In other words, the block voltage initial values Vai (i=1 to m) are stored in, for example, the storage 113. Next, the accumulator 112 acquires the overall current value IAA detected by the overall current detector AA (step S3). Further, in order to accumulate the overall current value IAA, the accumulator 112 assigns, to the current accumulated value Isum, the sum of the overall current value IAA acquired in step S3 and the current accumulated value Isum (step S4). The accumulator 112 compares the absolute value of the current accumulated value Isum with the current accumulated threshold value Ith (step S5). When the absolute value of the current accumulated value Isum is smaller than the current accumulated threshold value Ith (NO in step S5), the accumulator 112 returns to step S3 to continue accumulating the overall current value IAA. The interval of returning to step S3 and re-executing step 3 is preferably a constant cycle T.

Here, the current accumulated threshold value Ith is set to be a current accumulated value of a case where the block voltage decreases from the block voltage initial value Vai by a predetermined voltage or more. The current accumulated threshold value Ith is set so that a fact that the fuse F is disconnected may be detected, in a case where the fuse F, which is a cutoff element, is disconnected. This value may be determined based on a capacity of each of the cells (secondary batteries B) or the number of parallel cells (the basic cell number) n of each battery block BBi. In the above step S4, the overall current value IAA is accumulated to obtain the current accumulated value Isum, but the process to obtain the current accumulated value is not limited to this. Alternatively, the electrical quantity, which is obtained by multiplying the interval T by the current value, may be accumulated. The interval T is an interval of executing step S3. In other words, an electrical quantity accumulated value Qsum=0 may be set in step S1, and the electrical quantity may be accumulated using the formula: electrical quantity accumulated value Qsum=Qsum+IAA×T in step S4. This feature is applicable to the following embodiments as well.

When the absolute value |Isum| of the current accumulated value Isum is equal to or greater than the current accumulated threshold value Ith (YES in step S5), the voltage acquiring portion 111 acquires the block voltage value Vi detected by the block voltage detector VBi, and stores it in, for example, the storage 113 as the block voltage value Vbi (step S6). As with step S2, step S6 is executed for each of the battery blocks BB1 to BBm. In other words, the block voltage values Vbi (i=1 to m) are stored in, for example, the storage 113. Then, the accumulated value acquiring portion 114 calculates the estimated voltage value Vfr of a case where the current accumulated value Isum changes from the block voltage initial value Vai from a table of block voltages and electrical quantities. The table is stored in the storage 113 of the valid battery number estimation portion 101. Intermediate values of data that are set in the table may be obtained by linear interpolation and the like (step S7).

Then, the accumulated value acquiring portion 114 compares the difference (Vfr−Vbi) between the estimated voltage value Vfr and the block voltage value Vbi with the voltage threshold value Vth (step S8). When the difference (Vfr−Vbi) between the estimated voltage value Vfr and the block voltage value Vbi is smaller than the voltage threshold value Vth (NO in step S8), the accumulated value acquiring portion 114 may determine that none of the cutoff elements is disconnected, and returns to step S1. When the difference (Vfr−Vbi) between the estimated voltage value Vfr and the block voltage value Vbi is equal to or greater than the voltage threshold value Vth (YES in step S8), the accumulated value acquiring portion 114 determines that there is a disconnected cutoff element, and proceeds to step S9. Subsequently, the accumulated value acquiring portion 114 calculates the ideal current accumulated value Irsum-i (i=1 to m) required to reach the block voltage value Vbi from the block voltage initial value Vai from the table of voltages and electrical quantities, the table being stored in the storage 113 of the valid battery number estimation portion 101 (step S9). In other words, the ideal current accumulated values Irsum-1 to Irsum-m of the battery blocks BB1 to BBm are calculated. The ratio calculation portion 115 obtains the valid battery ratio from Isum/Irsum-i (i=1 to m), and calculates the number of valid batteries ENi (i=1 to m) from the formula: ENi=the basic cell number×the valid battery ratio=n×Isum/Irsum-i (step S10).

Subsequent to step S10, the ratio calculation portion 115 of the valid battery number estimation portion 101 calculates the minimum of the numbers of valid batteries ENi (EN1 to ENm) as the minimum valid battery number ENmin (step S11). By setting the current limit value Iu based on this minimum valid battery number ENmin, it is possible to set the current limit value Iu in accordance with the battery block BB that has the most disconnected fuses F and hence the lowest value of chargeable current and dischargeable current.

Next, the current limit value setting portion 102 calculates the current limit value Iu using the formula (1) (step S12). With the formula (1), the current limit value Iu is set in such a manner as to become smaller as the minimum valid battery number ENmin estimated by the valid battery number estimation portion 101 lowers.

Specifically, with the formula (1), the current limit value Iu may be set in such a manner that a value of current, which flows through one of the secondary batteries B connected in series to a connected fuse F when one or more fuses F are disconnected, does not exceed a value of current, which flows through one of the secondary batteries Bi-1 to Bi-n of the battery block BBi when none of the fuses F is disconnected and when the current at the standard current limit value Is flows through this battery block BBi.

Next, the current limit value Iu is output to the communication portion 11 by the current limit value setting portion 102, and transmitted to the charge-discharge controller 21 via the communication portion 24 by the communication portion 11 (step S13).

Consequently, the charge-discharge controller 21 limits the values of currents flowing through the battery blocks BB1 to BBm of the battery power supply apparatus 1 not to exceed the current limit value Iu. Therefore, a risk of deterioration is decreased. The deterioration is caused by a fact that some of the fuses F of the battery block BB are disconnected and, consequently, some of the secondary batteries B are disconnected, increasing the current flowing through the rest of the secondary batteries B. The deterioration is a deterioration of this rest of the secondary batteries B.

Note that an example of series-connected plural battery blocks BB is illustrated, but there may be only one battery block BB.

In addition, the number of valid batteries ENi of each battery block BBi is calculated in FIG. 2 according to the first embodiment, but the present invention is not limited to this configuration.

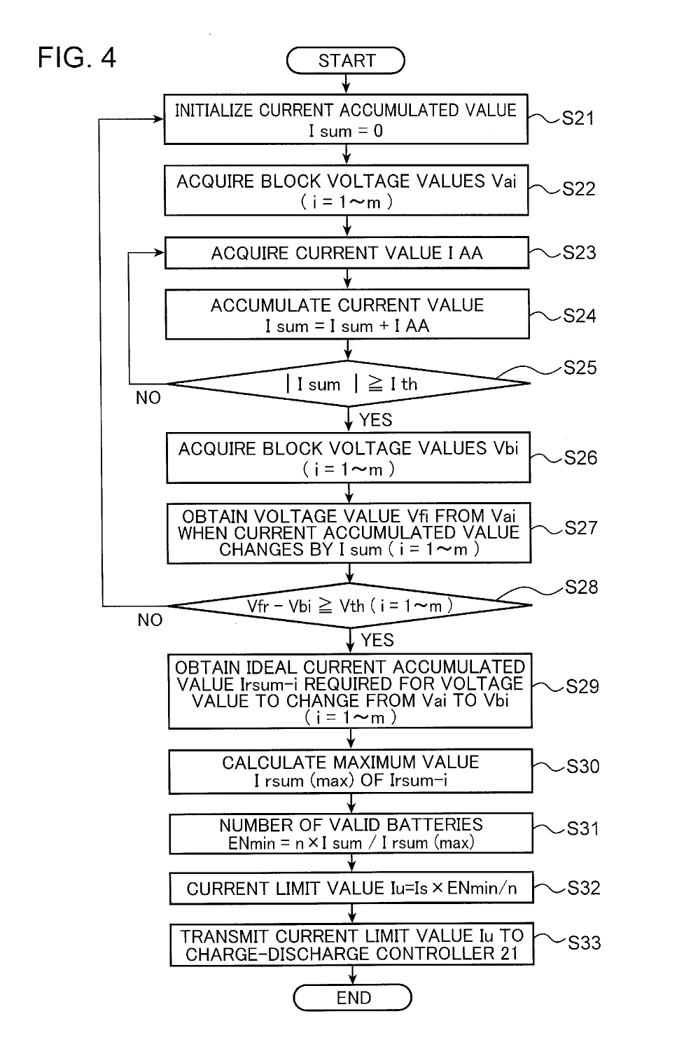

FIG. 4 is a flowchart showing another example of the operations performed in the battery power supply apparatus 1 shown in FIG. 1. In FIG. 4, steps S21 to S29 are the same as steps S1 to S9 of FIG. 2. Subsequent to step S29, the accumulated value acquiring portion 114 calculates the maximum ideal current accumulated value Irsum(max) out of the ideal current accumulated values Irsum-1 to Irsum-m (step S30). Then, the ratio calculation portion 115 obtains the valid battery ratio from Isum/Irsum(max), and further calculates the minimum valid battery number ENmin from the formula: ENmin=the basic cell number×valid battery ratio=n×Isum/Irsum(max) (step S31). The subsequent steps S32, S33 are the same as steps S12, S13 shown in FIG. 2. As with the operations shown in FIG. 2, the operations illustrated in FIG. 4 may favorably obtain the current limit value Iu.

### Second Embodiment

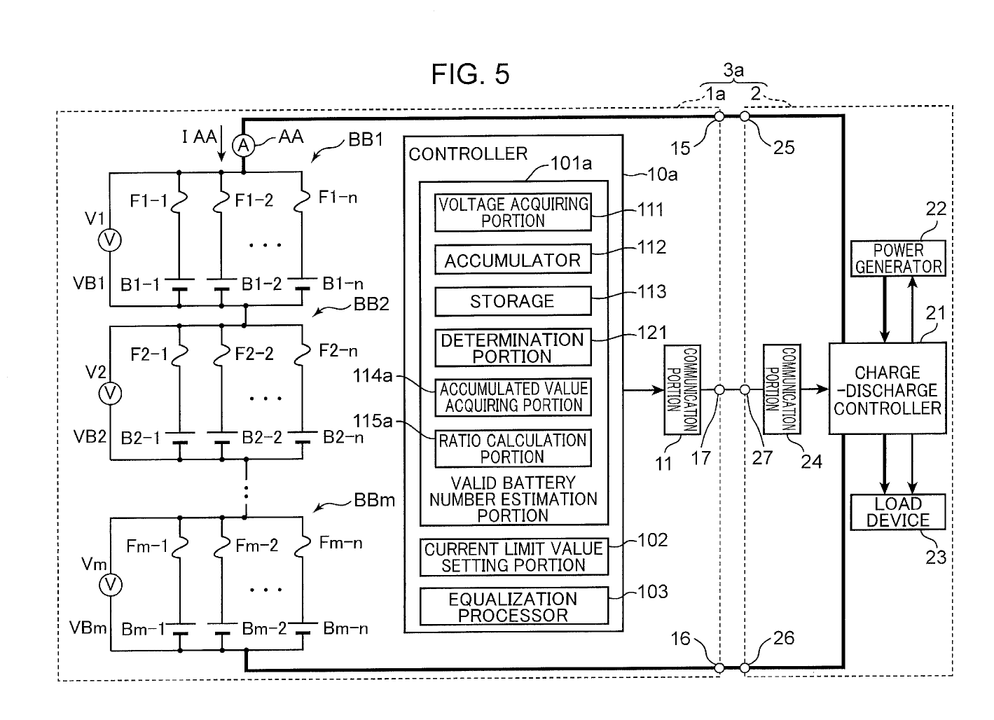

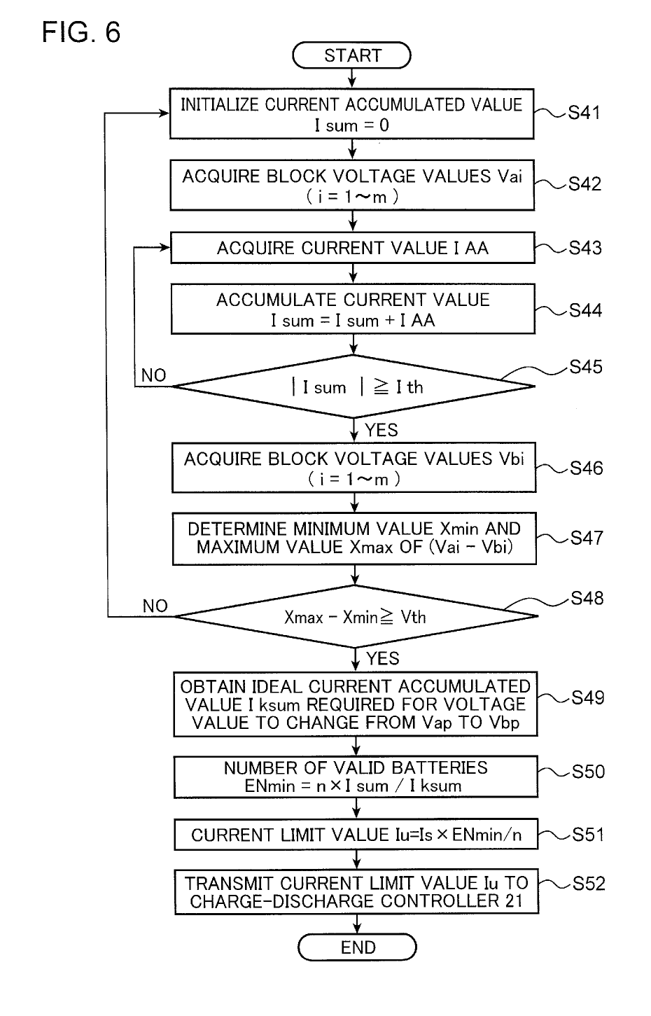

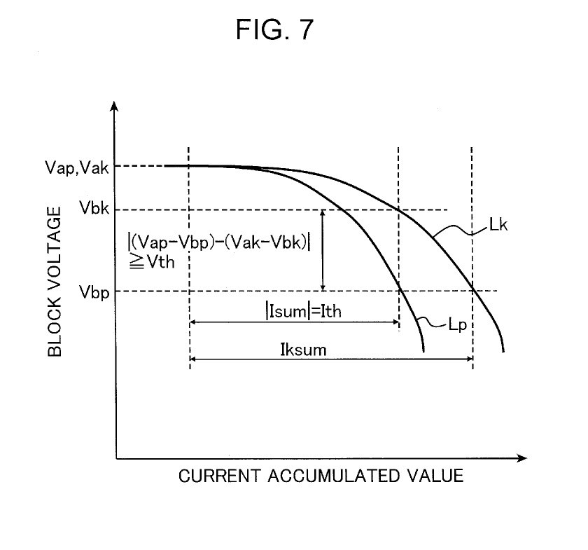

Next, a battery power supply system 3a having a battery power supply apparatus according to the second embodiment of the present invention is described. FIG. 5 is a block diagram showing an example of the battery power supply system having the battery power supply apparatus according to the second embodiment of the present invention. FIG. 6 is a flowchart showing an example of operations performed by the battery power supply system 3a according to the second embodiment of the present invention. FIG. 7 is a diagram showing the relationship between the block voltage values of a battery block and the current accumulated values of the overall current value according to the second embodiment. In the second embodiment, the similar reference numerals are assigned to the components similar to those described in the first embodiment.

The battery power supply system 3a of the second embodiment shown in FIG. 5 has a battery power supply apparatus 1a in place of the battery power supply apparatus 1 in the battery power supply system 3 of the first embodiment shown in FIG. 1, a controller 10a in place of the controller 10 in the battery power supply system 3 of the first embodiment shown in FIG. 1, and a valid battery number estimation portion 101a in place of the valid battery number estimation portion 101 in the battery power supply system 3 of the first embodiment shown in FIG. 1. The controller 10a has the valid battery number estimation portion 101a, the current limit value setting portion 102, and an equalization processor 103. The following describes the second embodiment, based mainly on the differences with the first embodiment.

One of the differences between the second embodiment and the first embodiment is that the second embodiment compares the actual block voltage values of the battery blocks with each other, while the first embodiment compares the block voltage value Vbi, obtained after the currents are accumulated, with the estimated voltage value Vfr using the table stored in the valid battery number estimation portion 101 and showing a relationship between voltages and electrical quantities.

The equalization processor 103 performs an equalization process to make the block voltage values Vi (i=1 to m) of the battery blocks BBi become equal to one another. The equalization processor 103 performs this equalization process by, for example, forcibly discharging the secondary batteries B of each battery block BB individually. The equalization processor 103 carries out this equalization process immediately prior to the execution of the operations shown in FIG. 6. The equalization processor 103 may not perform the equalization process when, for example, the voltage difference value between the block voltage values Vi of the battery blocks BBi is equal to or lower than a predetermined value (e.g., 3%). Note that the equalization processor 103 may not be essential to the present invention and therefore may not be provided in the battery power supply system 3a.

As shown in FIG. 5, the valid battery number estimation portion 101a of the second embodiment includes the voltage acquiring portion 111, the accumulator 112, the storage 113, a determination portion 121, an accumulated value acquiring portion 114a, and a ratio calculation portion 115a. The determination portion 121 obtains voltage change values of the block voltage values Vi acquired by the voltage acquiring portion 111 for each of the battery blocks BB, and determines the minimum voltage change value and the maximum voltage change value among the voltage change values obtained for each of the battery blocks BB. The determination portion 121 determines whether or not the difference value between the minimum voltage change value and the maximum voltage change value is equal to or greater than the voltage threshold value Vth. The determination portion 121 determines that the number of valid batteries is lowered, when it is determined that the difference value is equal to or greater than the voltage threshold value Vth, and that the number of valid batteries is not lowered, when it is determined that the difference value is less than the voltage threshold value Vth.

The accumulated value acquiring portion 114a acquires an ideal current accumulated value Iksum based on the block voltage values Vi of the battery block BBi acquired by the voltage acquiring portion 111 and the relationship between block voltages and electrical quantities which is stored in the storage 113. The ratio calculation portion 115a calculates a valid battery ratio, which is a ratio of the number of valid batteries ENi to the number of secondary batteries B (the basic cell number n) of a single battery block BB, using the ideal current accumulated value Iksum. Specific operations performed by each component of the valid battery number estimation portion 101a are described hereinafter.

In FIG. 7, the horizontal axis represents the current accumulated values, and the vertical axis represents the block voltages. A line Lk represents a relationship between the block voltage values of the battery block BB and the current accumulated values of the overall current value IAA in a case where an initial block voltage is a block voltage initial value Vak and none of the cutoff elements (fuses F) is disconnected. In the battery block BB with no disconnected fuses F out of the battery blocks BB1 to BBm, the block voltage value and the current accumulated value fluctuate as shown by the line Lk. The line Lk is stored as table data in the storage 113. A line Lp represents a relationship between the block voltage values of the battery block BB and the current accumulated values of the overall current value IAA in a case where an initial block voltage is a block voltage initial value Vap and the battery block BB has the most disconnected cutoff elements (fuses F) among the battery blocks BB1 to BBm. Note in the second embodiment that Vak=Vap is established, since the equalization process is executed by the equalization processor 103.

As shown by the line Lp, charging and discharging, which start from the block voltage initial value Vap, are repeatedly executed. Consequently, a block voltage, which is obtained when the absolute value |Isum| of the current accumulated value reaches the current accumulated threshold value Ith, is a block voltage value Vbp. Further, as shown by the line Lk, charging and discharging are repeatedly executed which start from the block voltage initial value Vak. Consequently, the block voltage, which is obtained when the absolute value |Isum| of the current accumulated value reaches the current accumulated threshold value Ith, is a block voltage value Vbk.

In the second embodiment, the voltage acquiring portion 111 acquires the block voltage initial value Vai and the block voltage value Vbi which is obtained when the absolute value |Isum| of the current accumulated value reaches the current accumulated threshold value Ith, in all of the battery blocks BBi (i=1 to m). The determination portion 121 calculates a voltage change value Xi=(Vai−Vbi) (i=1 to m). The determination portion 121 determines that the battery block BB with the maximum voltage change values out of the calculated voltage change values X1 to Xm has the most disconnected fuses F. The line Lp in FIG. 7 represents a relationship between the block voltage of the battery block BB and the current accumulated value. The battery block BB is determined to have the most disconnected fuses F. The determination portion 121 calculates the maximum voltage change value Xmax=(Vap−Vbp) corresponding to the line Lp, with the block voltage values Vai, Vbi of the battery block BBi as the block voltages Vap, Vbp. The battery block BBi is determined to have the most disconnected fuses F.

The determination portion 121 further determines that disconnected fuses F do not exist in the battery block BB having the minimum voltage change value out of the voltage change values X1 to Xm. The line Lk in FIG. 7 represents a relationship between the block voltage of the battery block BB and the current accumulated value. The battery block BB is determined to have no disconnected fuses F. The determination portion 121 then calculates the minimum voltage change value Xmin=(Vak−Vbk) corresponding to the line Lk, with the block voltage values Vai, Vbi of the battery block BBi as the block voltage values Vak, Vbk. The battery block BBi is determined to have no disconnected fuses F.

The relationship shown by the line Lk, stored in the storage 113, is used when the accumulated value acquiring portion 114a calculates the ideal current accumulated value Iksum that is required for the block voltage to change from the block voltage initial value Vak to the block voltage value Vbp. In other words, in the second embodiment, the block voltage values Vap, Vbp, Vak, Vbk are all measured values detected by the block voltage detector VBi, and the estimated voltage value Vfr as in the first embodiment does not exist. In the present embodiment, the overall current detector AA is an example of the first detector, the block voltage detector VBi is an example of the second detector, the current limit value setting portion 102 is an example of the setting portion, and the valid battery number estimation portion 101a is an example of the estimation portion. Moreover, in the present embodiment, the voltage acquiring portion 111 is an example of first and second acquiring portions, the accumulated value acquiring portion 114 is an example of the third acquiring portion, and the ratio calculation portion 115 is an example of the calculation portion. In the present embodiment, the block voltage initial value Vai is an example of the first block voltage value, and the block voltage value Vbi is an example of the second block voltage value. In addition, in the present embodiment, the communication portion 11 is an example of the current controller. In the present embodiment, the load device 23 is an example of the load circuit, and the power generator 22 is an example of the current supplier.

The operations are described hereinafter using the flowchart shown in FIG. 6.

First, when there is no abnormality in any of the secondary batteries B of the battery blocks BB1 to BBm and none of the fuses F is disconnected (fused), the current limit value setting portion 102 sets the standard current limit value Is as the initial value of the current limit value Iu. This current limit value Iu is then notified to the charge-discharge controller 21.

In this manner, the absolute value of the value of the overall current IAA flowing through each of the battery blocks BB1 to BBm is controlled by the charge-discharge controller 21 not to exceed the standard current limit value Is. In this second embodiment, the equalization processor 103 executes the equalization process on each of the secondary batteries B of the battery blocks BB1 to BBm, and the operations shown in FIG. 6 are started after the block voltage values Vi are made substantially equal to one another.

Next, in order to initialize the current accumulated value, 0 is assigned to the current accumulated value Isum (step S41). The voltage acquiring portion 111 acquires a block voltage value Vi detected by the block voltage detector VBi, and stores it in, for example, the storage 113 as the block voltage initial value Vai (step S42). This step S42 is executed for the battery blocks BB1 to BBm. In other words, the block voltage initial values Vai (i=1 to m) are stored in the storage 113. Note that, in this second embodiment, the block voltage initial values Vai (i=1 to m) become substantially equal to one another, since the equalization process is executed by the equalization processor 103.

Next, the accumulator 112 acquires the overall current value IAA detected by the overall current detector AA (step S43). Further, in order to accumulate the overall current value IAA, the accumulator 112 assigns, to the current accumulated value Isum, the sum of the overall current value IAA acquired in step S43 and the current accumulated value Isum (step S44). The accumulator 112 compares the absolute value |Isum| of the current accumulated value Isum with the current accumulated threshold value Ith (step S45). When the absolute value |Isum| of the current accumulated value Isum is smaller than the current accumulated threshold value Ith (NO in step S45), the accumulator 112 returns to step S43 to continue accumulating the overall current value IAA. The interval of returning to step S43 and re-executing step 43 is preferably a constant cycle T1. Here, the current accumulated threshold value Ith is set to be a current accumulated value of a case where the block voltage decreases from the block voltage initial value Vai by a predetermined voltage or more. The current accumulated threshold value Ith is set so that a fact that the fuse F is disconnected may be detected, in a case where the fuse F as a cutoff element is disconnected. This value may be determined based on the capacity of each of the cells (secondary batteries B) or the number of parallel cells (the basic cell number) n of each battery block BBi.

When the absolute value |Isum| of the current accumulated value Isum is equal to or greater than the current accumulated threshold value Ith (YES in step S45), the voltage acquiring portion 111 acquires a block voltage value Vi detected by the block voltage detector VBi, and stores it in, for example, the storage 113 as the block voltage value Vbi (step S46). As with step S42, step S46 is executed for each of the batteries blocks BB1 to BBm. In other words, the block voltage values Vbi (i=1 to m) are stored in, for example, the storage 113. Subsequently, the determination portion 121 determines the minimum value Xmin=(Vak−Vbk) and the maximum value Xmax=(Vap−Vbp) from the voltage change values (Vai−Vbi) of the battery blocks BB1 to BBm (step S47).

Then, the accumulated value acquiring portion 114a compares the difference value (Xmax−Xmin) between the minimum voltage change value Xmin and the maximum voltage change value Xmax with the voltage threshold value Vth (step S48). When the difference value (Xmax−Xmin) is smaller than the voltage threshold value Vth (NO in step S48), the determination portion 121 may determine that none of the cutoff elements is disconnected, and returns to step S41. When the difference value (Xmax−Xmin) is equal to or greater than the voltage threshold value Vth (YES in step S48), the determination portion 121 determines that there is a disconnected cutoff element, and proceeds to step S49.

The determination portion 121 determines that a battery block BBk having the voltage change value (Vai−Vbi) as the minimum voltage change value Xmin=(Vak−Vbk) does not have any disconnected fuse F. The determination portion 121 determines that a battery block BBp having the voltage change value (Vai−Vbi) as the maximum voltage change value Xmax=(Vap−Vbp) has the most disconnected fuses F among the battery blocks BB1 to BBm.

Subsequently, from the table of voltages and electrical quantities that is held in the storage 113 of the valid battery number estimation portion 101a, the accumulated value acquiring portion 114a calculates the ideal current accumulated value Iksum that is required to reach the block voltage value Vbp from the block voltage initial value Vak (step S49). The ratio calculation portion 115a obtains the valid battery ratio from Isum/Iksum and calculates the minimum valid battery number ENmin from the formula: ENi=the basic cell number×the valid battery ratio=n×Isum/Iksum (step S50).

By setting the current limit value Iu based on this minimum valid battery number ENmin, it is possible to set the current limit value Iu in accordance with the battery block BB that has the most disconnected fuses F and hence the lowest value of current capable of charging and discharging.

Next, the current limit value setting portion 102 calculates the current limit value Iu using the above formula (1) (step S51). With the formula (1), the current limit value Iu is set in such a manner as to become smaller as the minimum valid battery number ENmin estimated by the valid battery number estimation portion 101a lowers.

Specifically, with the formula (1), the current limit value Iu may be set in such a manner that a value of current, which flows through one of the secondary batteries B connected in series to a connected fuse F when one or more fuses F are disconnected, does not exceed a value of current, which flows through one of the secondary batteries Bi1 to Bin of the battery block when none of the fuses F is disconnected and when a current at the standard current limit value Is flows through this battery block BBi.

Next, the current limit value Iu is output to the communication portion 11 by the current limit value setting portion 102, and is transmitted to the charge-discharge controller 21 via the communication portion 24 by the communication portion 11 (step S52).

Consequently, the charge-discharge controller 21 controls values of current flowing through the battery blocks BB1 to BBm of the battery power supply apparatus 1a not to exceed the current limit value Iu. Therefore, a risk of deterioration is decreased. The deterioration is caused by a fact that some of the fuses F of the battery block BB are disconnected and, consequently, some of the secondary batteries B are disconnected, increasing the current flowing through the rest of the secondary batteries B. The deterioration is a deterioration of this rest of the secondary batteries B.

Note that an example in which plural (m) battery blocks BB are connected in series was described above, but the number of battery blocks BB may be two or more (i.e., m is an integer of two or more).

In the above second embodiment, the table showing a relationship between voltages and electrical quantities is stored in the storage 113, and the number of valid batteries is obtained by converting the voltage values into the current accumulated values using the table; however, the configuration of the present invention is not limited thereto. For instance, the number of valid batteries may be obtained based on the voltage values without converting the voltage values into the current accumulated values.

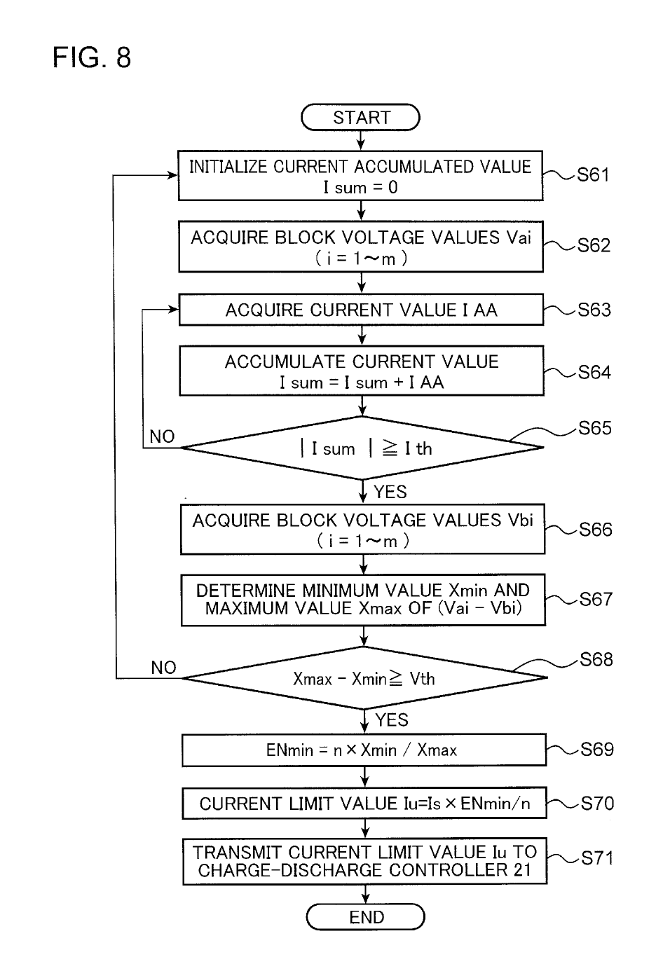

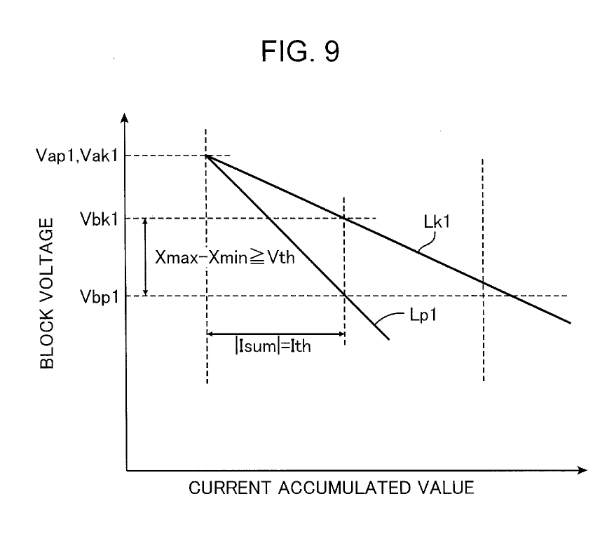

FIG. 8 is a flowchart showing another example of operations performed in the battery power supply system 3a according to the second embodiment of the present invention. FIG. 9 is a diagram showing a relationship between the block voltage values of a battery block and the current accumulated values of the overall current value according to the embodiment shown in FIG. 8.

In FIG. 9, the horizontal axis represents the current accumulated values, and the vertical axis represents the block voltages. A line Lk1 shows a relationship between the block voltage values of the battery block BB and the current accumulated values in a case where an initial block voltage is a block voltage initial value Vak1 and none of the cutoff elements (fuses F) is disconnected. In this modified embodiment, the line Lk1 is not stored as table data in the storage 113. A line Lp1 shows the relationship between the block voltage of the battery block BB and the current accumulated value of the overall current value IAA, the battery block BB having the most disconnected cutoff elements (fuses F) among the battery blocks BB1 to BBm, with an initial block voltage being a block voltage initial value Vap1. Note that, as with the second embodiment, also in this modified embodiment, Vak1=Vap1 is satisfied, since the equalization process is executed by the equalization processor 103.

As shown by the line Lp1, charging and discharging, which start from the block voltage initial value Vap1, are repeatedly executed. Consequently, a block voltage, which is obtained when the absolute value |Isum| of the current accumulated value Isum reaches the current accumulated threshold value Ith, is a block voltage value Vbp1. Further, as shown by the line Lk1, charging and discharging, which start from the block voltage initial value Vak1, are repeatedly executed. Consequently, a block voltage, which is obtained when the absolute value |Isum| of the current accumulated value Isum reaches the current accumulated threshold value Ith, is a block voltage value Vbk1.

In this modified embodiment, the voltage acquiring portion 111 acquires the block voltage initial value Vai and the block voltage value Vbi which is obtained when the absolute value |Isum| of the current accumulated value reaches the current accumulated threshold value Ith, in all of the battery blocks BBi (i=1 to m). The determination portion 121 calculates a voltage change value Xi=(Vai−Vbi) (i=1 to m). The determination portion 121 determines that the battery block BB with the maximum voltage change value out of the calculated voltage change values X1 to Xm has the most disconnected fuses F. The line Lp1 in FIG. 9 shows a relationship between the block voltage of the battery block BB and the current accumulated value. The battery block BB is determined to have the most disconnected fuses F. The determination portion 121 calculates the maximum voltage change value Xmax=(Vap1−Vbp1) corresponding to the line Lp1, with the block voltage values Vai, Vbi of the battery block BBi as the block voltages Vap1, Vbp1, the battery block BBi being determined to have the most disconnected fuses F.

The determination portion 121 further determines that disconnected fuses F do not exist in the battery block BB having the minimum voltage change value out of the voltage change values X1 to Xm. The line Lk1 in FIG. 9 shows a relationship between the block voltage of the battery block BB and the current accumulated value, the battery block BB being determined to have no disconnected fuses F. The determination portion 121 then calculates the minimum voltage change value Xmin=(Vak1−Vbk1) corresponding to the line Lk1, with the block voltage values Vai, Vbi of the battery block BBi as the block voltage values Vak1, Vbk1, the battery block BBi being determined to have no disconnected fuses F.

As shown in FIG. 9, the relationships between the block voltages of the battery blocks BB and the current accumulated values have linearity. In general, in a narrow SOC range (e.g., between SOC 60% and SOC 70%, that is, the current accumulated threshold value Ith is approximately 1/10 of the battery capacity), it may be considered that the relationships between the voltage values and the current accumulated values have linearity. When the relationships between the voltage values and the current accumulated values have linearity, the number of valid batteries may be obtained without converting a voltage value into a current accumulated value. In this modified embodiment, therefore, the line Lk1 is not stored as table data in the storage 113. Moreover, this modified embodiment is not required to have the accumulated value acquiring portion 114a. According to this modified embodiment, the operations shown in FIG. 8 are started in the region where the SOC of each secondary battery B is low. The operations are described hereinafter using the flowchart of FIG. 8.

In FIG. 8, steps S61 to S68 are the same as steps S41 to S48 shown in FIG. 6. In step S69, the ratio calculation portion 115a obtains the valid battery ratio from Xmin/Xmax, and calculates the minimum valid battery number ENmin from the formula: ENi=the basic cell number×valid battery ratio=n×Xmin/Xmax. The subsequent steps S70, S71 are the same as steps S51, S52 shown in FIG. 6.

As described above, in this modified embodiment, the operations shown in FIG. 8 are performed in the region with a low SOC of the secondary battery B (e.g., the region where the SOC is 30% or lower) that is considered to have a linear relationship between voltage values and current accumulated values. According to this modified embodiment, therefore, the minimum number of valid batteries may easily be obtained without converting a voltage value into a current accumulated value.

In each of the embodiments described above, the accumulator 112 accumulates the current values when the battery blocks are charged and discharged. Especially when charging and discharging of each battery block BB are frequently executed alternately, it is preferable that the current values be accumulated when both charging and discharging of the battery block BB are executed.

In addition, the operations described in FIGS. 2 and 4 may be started at any time. In other words, the operations described in FIGS. 2 and 4 may be started in any state of the secondary batteries B. However, the region with a low SOC of each secondary battery B is likely to generate a large difference between the block voltage value Vbi obtained when one of the fuses F is disconnected and the estimated voltage value Vfr obtained when none of the fuses F is disconnected. Therefore, it is preferable that the operations described in FIGS. 2 and 4 be started in the region with a low SOC of each secondary battery B.

In FIGS. 2, 4, 6 and 8, the difference value between the block voltage values is compared with the voltage threshold value Vth; however, it is not necessary to compare the difference value with the voltage threshold value Vth. Steps S8, S28, S48 and S68 for comparing the difference value with the voltage threshold value Vth may be omitted. However, when the difference value is smaller than the voltage threshold value Vth, the minimum valid battery number ENmin is calculated to be equal to the basic cell number n. It is, therefore, preferable that a step for comparing the difference value with the voltage threshold value Vth be provided in order to eliminate unnecessary calculations and communications.

In each of the embodiments described above, the charge-discharge controller 21 is provided in the external device 2, and the current limit value Iu is transmitted from the current limit value setting portion 102 via the communication portion 11 to cause the charge-discharge controller 21 to limit the value of charge-discharge current flowing through each battery block BB, but the present invention is not limited to this. For example, the charge-discharge controller 21 may be provided in the battery power supply apparatuses 1, 1a. In this embodiment, the charge-discharge controller 21 corresponds to an example of the current controller.

The specific embodiments described above mainly include the inventions having the following configurations.

A battery power supply apparatus according to one aspect of the present invention has: a battery block, which includes a parallel circuit that has series circuits connected in parallel, each of the series circuits having a secondary battery and a cutoff element connected in series, each of the cutoff elements becoming a disconnected state to disconnect a charge-discharge path of the secondary battery connected in series thereto, when an abnormality occurs in the secondary battery; a first detector that detects an overall current value flowing through the battery block; a second detector that is connected in parallel to the series circuits to detect a block voltage value of the battery block; a setting portion that sets a current limit value as an upper-limit tolerance of the overall current value; and an estimation portion that estimates, as the number of valid batteries, the number of cutoff elements which have not become disconnected states among the cutoff elements of the battery block, based on the overall current value detected by the first detector and the block voltage value detected by the second detector, wherein the setting portion sets the current limit value so that the current limit value decreases as the number of valid batteries estimated by the estimation portion decreases.

According to this configuration, the battery block includes a parallel circuit that has series circuits connected in parallel, each of the series circuits having a secondary battery and a cutoff element connected in series. Each of the cutoff elements becomes a disconnected state to disconnect a charge-discharge path of the secondary battery connected in series thereto, when an abnormality occurs in the secondary battery. The first detector detects the overall current value flowing through the battery block. The second detector is connected in parallel to the series circuits to detect a block voltage value of the battery block. The setting portion sets a current limit value as an upper-limit tolerance of the overall current value. The estimation portion estimates, as the number of valid batteries, the number of cutoff elements which have not become disconnected states among the cutoff elements of the battery block, based on the overall current value detected by the first detector and the block voltage value detected by the second detector. The setting portion sets the current limit value so that the current limit value decreases as the number of valid batteries estimated by the estimation portion decreases.

As described above, each of the cutoff elements is connected in series to each of the secondary batteries that are connected in parallel, each of the cutoff elements becoming a disconnected state in case of abnormality in the secondary battery to disconnect the charge-discharge paths of the secondary battery. Hence, in a case where abnormalities in a part of the secondary batteries of the battery block occur, it is possible for the cutoff elements to disconnect the charge-discharge paths only the part of the secondary batteries having abnormalities included in the battery block. As a result, these secondary batteries with abnormalities may be prevented from being deteriorated, without inhibiting the charging-discharging of the battery power supply apparatus itself or the entire battery block.

At this time, when some of the cutoff elements become disconnected states, the currents flowing through the secondary batteries with the consequently disconnected charge-discharge paths are distributed to the rest of the secondary batteries whose charge-discharge paths remain connected. This consequently increases the currents flowing through the secondary batteries whose charge-discharge paths remain connected. Therefore, if the current limit value remains the same as the one obtained when none of the cutoff elements is disconnected, and even when the current value is equal to or less than the current limit value or falls within the allowable range in a unit of the battery block in a case where charging-discharging the battery block of the battery power supply apparatus based on this current limit value, the currents flowing through the rest of the secondary batteries whose charge-discharge paths remain connected might exceed the allowable current value of the secondary battery. This might deteriorate the secondary battery.

Therefore, the estimation portion estimates the number of cutoff elements which have not become disconnected states among the cutoff elements of the one battery block, as the number of valid batteries. Subsequently, the setting portion sets the current limit value so that the current limit value decreases as the number of valid batteries decreases. For this reason, when some of the cutoff elements become disconnected states, the number of valid batteries decreases, reducing the current limit value. Hence, charging-discharging the battery power supply apparatus or, in other words, the battery block based on this current limit value reduces the currents flowing through the secondary batteries whose charge-discharge paths remain connected. This may prevent these secondary batteries, whose charge-discharge paths remain connected, from being deteriorated.

In the above battery power supply apparatus, it is preferable that the upper-limit tolerance of the overall current value is defined as a standard current limit value, in a case where all of the cutoff elements included in the battery block are not in disconnected states, a ratio of the number of valid batteries to the number of secondary batteries included in one of the battery block is defined as a valid battery ratio, and the setting portion sets, as the current limit value, a value obtained by multiplying the standard current limit value by the valid battery ratio.

According to this configuration, the upper-limit tolerance of the overall current value, in a case where all of the cutoff elements included in the battery block are not in disconnected states, is defined as a standard current limit value. A ratio of the number of valid batteries to the number of secondary batteries included in one of the battery block is defined as a valid battery ratio. The setting portion sets, as the current limit value, a value obtained by multiplying the standard current limit value by the valid battery ratio.

Accordingly, the setting portion controls the current value flowing through the battery block not to exceed the current limit value. Therefore, in a case where a current at the standard current limit value flows through the battery block when none of the cutoff elements is disconnected, the current value may be controlled not to exceed the current value distributed to the secondary batteries, which is the allowable current value of each secondary battery. Therefore, the secondary batteries may easily be prevented from being deteriorated.

In the above battery power supply apparatus, it is preferable that the estimation portion includes: a first acquiring portion that acquires the block voltage of the battery block detected by the second detector, as a first block voltage value; an accumulator that starts accumulating the overall current value detected by the first detector, when the first block voltage value is acquired by the first acquiring portion; a second acquiring portion that acquires the block voltage of the battery block detected by the second detector as a second block voltage value, when a current accumulated value obtained by the accumulator becomes not less than a current accumulated threshold value determined in advance; a storage that stores in advance a relationship between the block voltage of the battery block and the current accumulated value of the overall current value; a third acquiring portion that acquires a current accumulated value as an ideal current accumulated value from the relationship stored in the storage, the current accumulated value being required for the block voltage to change from the first block voltage value to the second block voltage value; and a calculation portion that divides the current accumulated threshold value by the ideal current accumulated value to calculate a quotient as the valid battery ratio.

According to this configuration, the first acquiring portion acquires the block voltage of the battery block detected by the second detector, as a first block voltage value. The accumulator starts accumulating the overall current value detected by the first detector, when the first block voltage value is acquired by the first acquiring portion. The second acquiring portion acquires the block voltage of the battery block detected by the second detector as a second block voltage value, when a current accumulated value obtained by the accumulator becomes not less than a current accumulated threshold value determined in advance. The storage stores in advance a relationship between the block voltage of the battery block and the current accumulated value of the overall current value. The third acquiring portion acquires a current accumulated value as an ideal current accumulated value from the relationship stored in the storage, the current accumulated value being required for the block voltage to change from the first block voltage value to the second block voltage value. The calculation portion divides the current accumulated threshold value by the ideal current accumulated value to calculate a quotient as the valid battery ratio. Therefore, the number of valid batteries may favorably be estimated from the number of secondary batteries included in the one battery block and the valid battery ratio.

In the above battery power supply apparatus, it is preferable that a plurality of the battery blocks are connected in series, the second detector is provided in each of the plurality of the battery blocks, the first acquiring portion acquires the first block voltage value for each of the plurality of the battery blocks, the second acquiring portion acquires the second block voltage value for each of the plurality of the battery blocks, the third acquiring portion acquires the ideal current accumulated value for each of the plurality of the battery blocks, and the calculation portion divides the current accumulated threshold value by a maximum value of the ideal current accumulated values of the plurality of the battery blocks acquired by the third acquiring portion, to calculate a quotient as the valid battery ratio, or divides the current accumulated threshold value by each of the ideal current accumulated values of the plurality of the battery blocks acquired by the third acquiring portion, to calculate a minimum value out of quotients as the valid battery ratio.

According to this configuration, the plurality of the battery blocks are connected in series. The second detector is provided in each of the plurality of the battery blocks. The first acquiring portion acquires the first block voltage value for each of the plurality of the battery blocks. The second acquiring portion acquires the second block voltage value for each of the plurality of the battery blocks. The third acquiring portion acquires the ideal current accumulated value for each of the plurality of the battery blocks. The calculation portion divides the current accumulated threshold value by a maximum value of the ideal current accumulated values of the plurality of the battery blocks acquired by the third acquiring portion, to calculate a quotient as the valid battery ratio, or divides the current accumulated threshold value by each of the ideal current accumulated values of the plurality of the battery blocks acquired by the third acquiring portion, to calculate a minimum value out of quotients as the valid battery ratio. Thus, it is possible to favorably estimate the minimum number of valid batteries in the plurality of battery blocks.

In the above battery power supply apparatus, it is preferable that a plurality of the battery blocks are connected in series, the second detector is provided in each of the plurality of the battery blocks, and the estimation portion includes: a first acquiring portion that acquires the block voltage of each of the plurality of the battery blocks detected by the second detector, as a first block voltage value for each of the plurality of the battery blocks; an accumulator that starts accumulating the overall current value detected by the first detector, when the first block voltage value is acquired by the first acquiring portion; a second acquiring portion that acquires the block voltage of each of the plurality of the battery blocks detected by the second detector, as a second block voltage value for each of the plurality of the battery blocks, when a current accumulated value obtained by the accumulator becomes not less than a current accumulated threshold value determined in advance; a storage that stores in advance a relationship between the block voltage of each of the plurality of the battery blocks and the current accumulated value of the overall current value; a determination portion that calculates, for each of the plurality of the battery blocks, a voltage change value between each of the first block voltage values acquired by the first acquiring portion and each of the second block voltage values acquired by the second acquiring portion, to determine a maximum voltage change value out of the calculated voltage change values; a third acquiring portion that acquires a current accumulated value as an ideal current accumulated value from the relationship stored in the storage, the current accumulated value being required for the block voltage to change by the maximum voltage change value; and a calculation portion that divides the current accumulated threshold value by the ideal current accumulated value to calculate a quotient as the valid battery ratio.

According to this configuration, the plurality of battery blocks are connected in series. The second detector is provided in each of the plurality of the battery blocks. The first acquiring portion acquires the block voltage of each of the plurality of the battery blocks detected by the second detector, as a first block voltage value for each of the plurality of the battery blocks. The accumulator starts accumulating the overall current value detected by the first detector, when the first block voltage value is acquired by the first acquiring portion. The second acquiring portion acquires the block voltage of each of the plurality of the battery blocks detected by the second detector, as a second block voltage value for each of the plurality of the battery blocks, when a current accumulated value obtained by the accumulator becomes not less than a current accumulated threshold value determined in advance. The storage stores in advance a relationship between the block voltage of each of the plurality of the battery blocks and the current accumulated value of the overall current value. The determination portion calculates, for each of the plurality of the battery blocks, a voltage change value between each of the first block voltage values acquired by the first acquiring portion and each of the second block voltage values acquired by the second acquiring portion, to determine a maximum voltage change value out of the calculated voltage change values. The third acquiring portion acquires a current accumulated value as an ideal current accumulated value from the relationship stored in the storage, the current accumulated value being required for the block voltage to change by the maximum voltage change value. The calculation portion divides the current accumulated threshold value by the ideal current accumulated value to calculate a quotient as the valid battery ratio. In this configuration, the battery blocks having the maximum voltage change value have the most cutoff elements that have become disconnected states. Therefore, it is possible to favorably estimate the minimum number of valid batteries in the plurality of the battery blocks.

In the above battery power supply apparatus, it is preferable that a plurality of the battery blocks are connected in series, the second detector is provided in each of the plurality of the battery blocks, and the estimation portion includes: a first acquiring portion that acquires the block voltage of each of the plurality of the battery blocks detected by the second detector, as a first block voltage value for each of the plurality of the battery blocks; an accumulator that starts accumulating the overall current value detected by the first detector, when the first block voltage value is acquired by the first acquiring portion; a second acquiring portion that acquires the block voltage of each of the plurality of the battery blocks detected by the second detector, as a second block voltage value for each of the plurality of the battery blocks, when a current accumulated value obtained by the accumulator becomes not less than a current accumulated threshold value determined in advance; a determination portion that calculates, for each of the plurality of the battery blocks, a voltage change value between the first block voltage value acquired by the first acquiring portion and the second block voltage value acquired by the second acquiring portion, to determine a minimum voltage change value and a maximum voltage change value of the voltage change values; and a calculation portion that divides the minimum voltage change value by the maximum voltage change value to calculate a quotient as the valid battery ratio, when a difference between the minimum voltage change value and the maximum voltage change value is not less than a voltage threshold value determined in advance.

According to this configuration, the plurality of battery blocks are connected in series. The second detector is provided in each of the plurality of the battery blocks. The first acquiring portion acquires the block voltage of each of the plurality of the battery blocks detected by the second detector, as a first block voltage value for each of the plurality of the battery blocks. The accumulator starts accumulating the overall current value detected by the first detector, when the first block voltage value is acquired by the first acquiring portion. The second acquiring portion acquires the block voltage of each of the plurality of the battery blocks detected by the second detector, as a second block voltage value for each of the plurality of the battery blocks, when a current accumulated value obtained by the accumulator becomes not less than a current accumulated threshold value determined in advance. The determination portion calculates, for each of the plurality of the battery blocks, a voltage change value between the first block voltage value acquired by the first acquiring portion and the second block voltage value acquired by the second acquiring portion, to determine a minimum voltage change value and a maximum voltage change value of the voltage change values. The calculation portion divides the minimum voltage change value by the maximum voltage change value to calculate a quotient as the valid battery ratio, when a difference between the minimum voltage change value and the maximum voltage change value is not less than a voltage threshold value determined in advance. In this configuration, the battery blocks having the maximum voltage change value have the most cutoff elements that have become disconnected states, and the battery blocks having the minimum voltage change value have no cutoff elements that have become disconnected states. Therefore, it is possible to favorably estimate the minimum number of valid batteries in the plurality of battery blocks.

In the above battery power supply apparatus, it is preferable that the battery power supply apparatus further has an equalization processor that executes a process for equalizing each of the block voltages of each of the plurality of the battery blocks, wherein the first acquiring portion acquires the first block voltage value for each of the plurality of the battery blocks, following an end of the process executed by the equalization processor.

According to this configuration, the equalization processor executes a process for equalizing each of the block voltages of each of the plurality of the battery blocks. The first acquiring portion acquires the first block voltage value for each of the plurality of the battery blocks, following an end of the process executed by the equalization processor. As a result, it is possible to favorably compare the voltage change values corresponding to the block voltage values of the battery blocks with one another.

In the above battery power supply apparatus, it is preferable that the battery power supply apparatus further has a current controller that controls a current flowing through the battery block so that the overall current value does not exceed the current limit value set by the setting portion.

According to this configuration, the current controller controls a current flowing through the battery block so that the overall current value does not exceed the current limit value set by the setting portion. Therefore, even when some of the cutoff elements become disconnected states, a risk of an increase in the currents that flow through the secondary batteries connected in series to the cutoff elements that are not disconnected is reduced. As a result, it is possible to decrease a risk for the secondary batteries to be deteriorated.

In the battery power supply apparatus, it is preferable that the battery power supply apparatus is electrically connected to an external device that charges and discharges the battery block, and that the current controller transmits the current limit value set by the setting portion to the external device to thereby cause the external device to control the current flowing through the battery block not to exceed the current limit value.

According to this configuration, the battery power supply apparatus is electrically connected to an external device that charges and discharges the battery block. The current controller transmits the current limit value set by the setting portion to the external device to thereby cause the external device to control the current flowing through the battery block not to exceed the current limit value. Thus, even when some of the cutoff elements become disconnected state, a risk of an increase in the currents that flow through the secondary batteries connected in series to the cutoff elements that are not disconnected is reduced. As a result, it is possible to decrease a risk for the secondary batteries to be deteriorated.

A battery power supply system according to another aspect of the present invention has the above battery power supply apparatus and an external device that charges and discharges the battery block of the battery power supply apparatus, wherein the external device has: a load circuit that receives discharge current supplied from the battery block; a current supplier that supplies charging current to the battery block; and a charge-discharge controller that adjusts the discharge current supplied from the battery block to the load circuit and the charging current supplied from the current supplier to the battery block, so that a current flowing through the battery block does not exceed the current limit value set by the setting portion.

According to this configuration, the external device charges and discharges the battery block of the battery power supply apparatus. The load circuit receives discharge current supplied from the battery block; a current supplier that supplies charging current to the battery block. The current supplier supplies charging current to the battery block. The charge-discharge controller adjusts the discharge current supplied from the battery block to the load circuit and the charging current supplied from the current supplier to the battery block, so that a current flowing through the battery block does not exceed the current limit value set by the setting portion. Thus, even in a case where abnormalities occur in some of the secondary batteries of the battery block, it is possible to decrease a risk for the secondary batteries to be deteriorated, without inhibiting charge-discharge of the entire battery power supply apparatus.

In the battery power supply apparatus having the above configuration and the battery power supply system using this battery power supply apparatus, each of the cutoff elements that disconnects the charge-discharge path, when becoming a disconnected state, is connected in series to each of the secondary batteries which are connected in parallel. Therefore, in a case where abnormalities occur in a part of the secondary batteries of the battery block, it is possible for the cutoff elements to disconnect the charge-discharge paths only the part of the secondary batteries having abnormalities included in the battery block. As a result, it is possible to decrease a risk for the abnormal secondary batteries to be deteriorated, without inhibiting charge-discharge of the entire battery power supply apparatus.

In addition, the valid battery number estimation portion estimates, as the number of valid batteries, the number of cutoff elements, which have not become disconnected states, out of the cutoff elements included in one battery block. The setting portion sets the current limit value so that the current limit value decreases as the number of valid batteries decreases. Consequently, when some of the cutoff elements become disconnected states, the number of valid batteries lowers, reducing the current limit value. Accordingly, b charging-discharging the battery block of the battery power supply apparatus based on this current limit value, the currents flowing through the secondary batteries are reduced, the secondary batteries being connected in series to the cutoff elements that have not become disconnected states. As a result, it is possible to easily reduce a risk for the secondary batteries, connected in series to the cutoff elements that have not become disconnected states, to be deteriorated.

### INDUSTRIAL APPLICABILITY

The battery power supply apparatus and the battery power supply system using the battery power supply apparatus according to the present invention may favorably be used in electronic devices such as portable personal computers, digital cameras, and cellular phones, vehicles such as electric vehicles and hybrid vehicles, hybrid elevators, power supply systems with combinations of photovoltaic cells or power generators and secondary batteries, battery-powered apparatuses and battery-powered systems such as uninterruptible power supply devices.

1. A battery power supply apparatus, comprising:
a battery block, which includes a parallel circuit that has series circuits connected in parallel, each of the series circuits having a secondary battery and a cutoff element connected in series, each of the cutoff elements becoming a disconnected state to disconnect a charge-discharge path of the secondary battery connected in series thereto, when an abnormality occurs in the secondary battery;
a first detector that detects an overall current value flowing through the battery block;
a second detector that is connected in parallel to the series circuits to detect a block voltage value of the battery block;
a setting portion that sets a current limit value as an upper-limit tolerance of the overall current value; and
an estimation portion that estimates, as the number of valid batteries, the number of cutoff elements which have not become disconnected states among the cutoff elements of the battery block, based on the overall current value detected by the first detector and the block voltage value detected by the second detector, wherein
the setting portion sets the current limit value so that the current limit value decreases as the number of valid batteries estimated by the estimation portion decreases.

2. The battery power supply apparatus according to claim 1, wherein
the upper-limit tolerance of the overall current value is defined as a standard current limit value, in a case where all of the cutoff elements included in the battery block are not in disconnected states,
a ratio of the number of valid batteries to the number of secondary batteries included in one of the battery block is defined as a valid battery ratio, and
the setting portion sets, as the current limit value, a value obtained by multiplying the standard current limit value by the valid battery ratio.

3. The battery power supply apparatus according to claim 2, wherein
the estimation portion includes:
a first acquiring portion that acquires the block voltage of the battery block detected by the second detector, as a first block voltage value;
an accumulator that starts accumulating the overall current value detected by the first detector, when the first block voltage value is acquired by the first acquiring portion;
a second acquiring portion that acquires the block voltage of the battery block detected by the second detector as a second block voltage value, when a current accumulated value obtained by the accumulator becomes not less than a current accumulated threshold value determined in advance;
a storage that stores in advance a relationship between the block voltage of the battery block and the current accumulated value of the overall current value;
a third acquiring portion that acquires a current accumulated value as an ideal current accumulated value from the relationship stored in the storage, the current accumulated value being required for the block voltage to change from the first block voltage value to the second block voltage value; and
a calculation portion that divides the current accumulated threshold value by the ideal current accumulated value to calculate a quotient as the valid battery ratio.

4. The battery power supply apparatus according to claim 3, wherein
a plurality of the battery blocks are connected in series,
the second detector is provided in each of the plurality of the battery blocks,
the first acquiring portion acquires the first block voltage value for each of the plurality of the battery blocks,
the second acquiring portion acquires the second block voltage value for each of the plurality of the battery blocks,
the third acquiring portion acquires the ideal current accumulated value for each of the plurality of the battery blocks, and
the calculation portion divides the current accumulated threshold value by a maximum value of the ideal current accumulated values of the plurality of the battery blocks acquired by the third acquiring portion, to calculate a quotient as the valid battery ratio, or divides the current accumulated threshold value by each of the ideal current accumulated values of the plurality of the battery blocks acquired by the third acquiring portion, to calculate a minimum value out of quotients as the valid battery ratio.

5. The battery power supply apparatus according to claim 2, wherein
a plurality of the battery blocks are connected in series,
the second detector is provided in each of the plurality of the battery blocks, and
the estimation portion includes:
a first acquiring portion that acquires the block voltage of each of the plurality of the battery blocks detected by the second detector, as a first block voltage value for each of the plurality of the battery blocks;
an accumulator that starts accumulating the overall current value detected by the first detector, when the first block voltage value is acquired by the first acquiring portion;
a second acquiring portion that acquires the block voltage of each of the plurality of the battery blocks detected by the second detector, as a second block voltage value for each of the plurality of the battery blocks, when a current accumulated value obtained by the accumulator becomes not less than a current accumulated threshold value determined in advance;
a storage that stores in advance a relationship between the block voltage of each of the plurality of the battery blocks and the current accumulated value of the overall current value;
a determination portion that calculates, for each of the plurality of the battery blocks, a voltage change value between each of the first block voltage values acquired by the first acquiring portion and each of the second block voltage values acquired by the second acquiring portion, to determine a maximum voltage change value out of the calculated voltage change values;
a third acquiring portion that acquires a current accumulated value as an ideal current accumulated value from the relationship stored in the storage, the current accumulated value being required for the block voltage to change by the maximum voltage change value; and
a calculation portion that divides the current accumulated threshold value by the ideal current accumulated value to calculate a quotient as the valid battery ratio.

6. The battery power supply apparatus according to claim 2, wherein
a plurality of the battery blocks are connected in series,
the second detector is provided in each of the plurality of the battery blocks, and
the estimation portion includes:
a first acquiring portion that acquires the block voltage of each of the plurality of the battery blocks detected by the second detector, as a first block voltage value for each of the plurality of the battery blocks;
an accumulator that starts accumulating the overall current value detected by the first detector, when the first block voltage value is acquired by the first acquiring portion;
a second acquiring portion that acquires the block voltage of each of the plurality of the battery blocks detected by the second detector, as a second block voltage value for each of the plurality of the battery blocks, when a current accumulated value obtained by the accumulator becomes not less than a current accumulated threshold value determined in advance;
a determination portion that calculates, for each of the plurality of the battery blocks, a voltage change value between the first block voltage value acquired by the first acquiring portion and the second block voltage value acquired by the second acquiring portion, to determine a minimum voltage change value and a maximum voltage change value of the voltage change values; and
a calculation portion that divides the minimum voltage change value by the maximum voltage change value to calculate a quotient as the valid battery ratio, when a difference between the minimum voltage change value and the maximum voltage change value is not less than a voltage threshold value determined in advance.

7. The battery power supply apparatus according to claim 5, further comprising an equalization processor that executes a process for equalizing each of the block voltages of each of the plurality of the battery blocks, wherein
the first acquiring portion acquires the first block voltage value for each of the plurality of the battery blocks, following an end of the process executed by the equalization processor.

8. The battery power supply apparatus according to claim 1, further comprising a current controller that controls a current flowing through the battery block so that the overall current value does not exceed the current limit value set by the setting portion.

9. The battery power supply apparatus according to claim 8, wherein
the battery power supply apparatus is electrically connected to an external device that charges and discharges the battery block, and
the current controller transmits the current limit value set by the setting portion to the external device to thereby cause the external device to control the current flowing through the battery block not to exceed the current limit value.

10. A battery power supply system, comprising:
the battery power supply apparatus of claim 1; and
an external device that charges and discharges the battery block of the battery power supply apparatus, wherein
the external device has:
a load circuit that receives discharge current supplied from the battery block;
a current supplier that supplies charging current to the battery block; and
a charge-discharge controller that adjusts the discharge current supplied from the battery block to the load circuit and the charging current supplied from the current supplier to the battery block, so that a current flowing through the battery block does not exceed the current limit value set by the setting portion.
